(19) United States
(12) Patent Application Publication
(10) Pub. No.: US 2024/0147354 A1
(43) Pub. Date: May 2, 2024

(54) System and Method for Abbreviating Channel Scans

(71) Applicant: ZEBRA TECHNOLOGIES CORPORATION, Lincolnshire, IL (US)

(72) Inventors: Jonathan Chen, Medford, NY (US); Mahesh Kumar Edar, Davenagere (IN)

(21) Appl. No.: 17/976,537

(22) Filed: Oct. 28, 2022

(51) Int. Cl. H04W 48/16; H04W 24/10

(52) U.S. Cl. CPC H04W 48/16; H04W 24/10

(57) ABSTRACT

A computing device comprising: a wireless communications interface configured to connect to a network deployed by a plurality of access points; a controller for the wireless communications interface, the controller configured to: initiate an access point scan to identify nearby access points; during the access point scan: obtain a neighbor report, the neighbor report defining a subset of the plurality of access points and an operating channel for each access point in the subset; select a channel to scan and identify an expected access point operating on the selected channel based on the neighbor report; initiate a channel scan to detect the expected access point on the selected channel; and in response to detecting the expected access point, end the channel scan prior to expiry of a default scan time; and connect to a target access point selected based on the access point scan.

### BACKGROUND

Wireless networks may be serviced by several access points to which devices can connect based on their location within the wireless network. When connecting to an access point or roaming between access points, the device may perform a scan to identify potential access points by performing channel scans to detect access points operating on a given channel. However, such channel scans require the device to move away from the home access point channel for the duration of the scan, which may cause packets to be dropped from ongoing communications.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for abbreviating channel scans.

FIG. 2 is a block diagram of certain internal hardware components of the computing device of FIG. 1.

FIG. 3 is a flowchart of a method of connecting to a target access point.

FIG. 4 is a flowchart of a method of performing an access point scan with abbreviated channel scans.

FIG. 5 is a schematic diagram of example channel scans performed during the method of FIG. 4.

FIG. 6 is a schematic diagram of further example channel scans performed during the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a computing device comprising: a wireless communications interface configured to connect to a network deployed by a plurality of access points; a controller for the wireless communications interface, the controller configured to: initiate an access point scan to identify nearby access points of the plurality of access points; during the access point scan: obtain a neighbor report, the neighbor report defining a subset of the plurality of access points and an operating channel for each access point in the subset; select a channel to scan and identify an expected access point operating on the selected channel based on the neighbor report; initiate a channel scan to detect the expected access point on the selected channel; and in response to detecting the expected access point, end the channel scan prior to expiry of a default scan time; and connect to a target access point selected based on the access point scan.

Additional examples disclosed herein are directed to a method comprising: initiating an access point scan to identify nearby access points of a plurality of access points; during the access point scan: obtaining a neighbor report, the neighbor report defining a subset of the plurality of access points and an operating channel for each access point in the subset; selecting a channel to scan and identify an expected access point operating on the selected channel based on the neighbor report; initiating a channel scan to detect the expected access point on the selected channel; and in response to detecting the expected access point, ending the channel scan prior to expiry of a default scan time; and connecting to a target access point selected based on the access point scan.

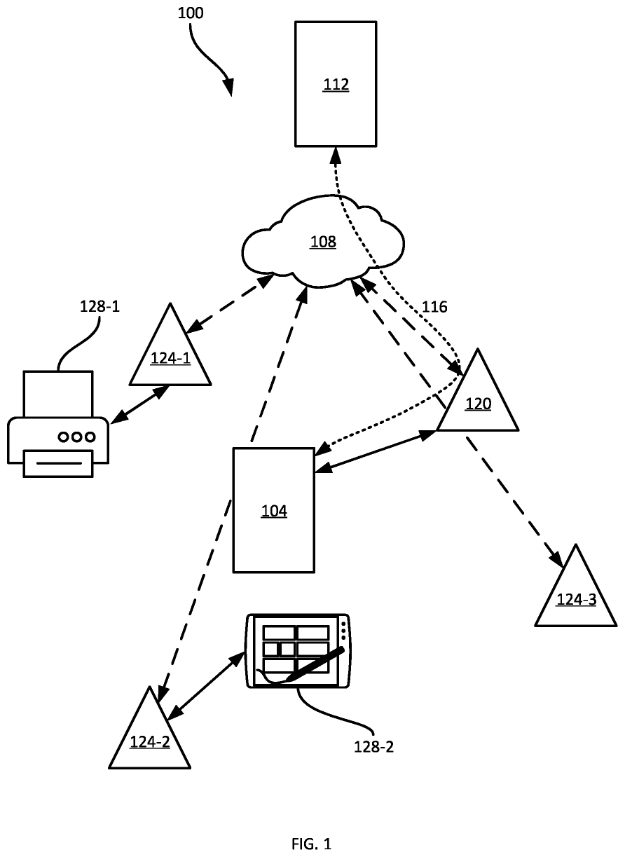

FIG. 1 depicts a system 100 abbreviating an access point scan in accordance with the teachings of this disclosure. The system 100 includes a computing device 104 (also referred to herein as simply the device 104) connected to a network 108. The device 104 may communicate with a second computing device 112 via a link 116 which traverses the network 108. In some examples, the device 112 may be remote from the device 104 and the link 116 may therefore additionally traverse one or more wide-area networks such as the Internet, mobile networks, and the like.

The device 104 may be a mobile computing device such as a handheld computer, a mobile phone, a tablet, a barcode scanner or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) deployed by one or more access point. In the present example, four example access points, a home access point 120, and three foreign access points 124-1, 124-2, and 124-3 are depicted. In other examples, the network 108 may include more or fewer access points.

In particular, the device 104 may be currently serviced by the home access point 120 to connect to the network 108. Since the device 104 may be mobile, the device 104 may be carried about by a user. As the user of the device 104 moves about the facility or other region serviced by the network 108, the connection of the device 104 to the home access point 120 may weaken, and the device 104 may be better serviced by another foreign access point 124 of the network 108. Accordingly, the device 104 may roam to one of the foreign access points 124 to connect to the network 108, for example when the device 104 is out of range of the home access point 120 and/or when a better connection may be achieved via one of the foreign access points 124.

To identify the foreign access points 124, the device 104 performs an access point scan. During the access point scan, the device 104 may perform multiple individual channel scans for each of a plurality of channels to identify access points 124 operating on a given channel. Together, the channel scans may form the access point scan. During each of the channel scans, the device 104 moves away from its current operating channel with the home access point 120, so ongoing communications (e.g., between the device 104 and the device 112) may be buffered until the device 104 returns to the operating channel of the home access point 120.

In accordance with the present disclosure, the device 104 may obtain a neighbor report from a nearby access point, such as the home access point 120 to which the device 104 is currently connected. In other examples, the device 104 may obtain a neighbor report from other nearby computing devices, such as devices 128-1 and 128-2. The nearby or neighboring computing devices 128 may be computing devices such as printers, laptops, desktop computers, fixed workstations, other mobile computing devices, such as scanners, tablets, mobile phones, or the like.

The neighbor report may include information, such as identification information and an operating channel, regarding the foreign access points 124. The device 104 may then use the information in the neighbor report to abbreviate the scan time for each individual channel scan. The neighbor report may be used to narrow down the list of channels to scan. Additionally, the device 104 may further reduce the scan time for the access point scan by abbreviating each of the individual channel scans. The device 104 may use the neighbor report to further identify, for each channel scan, an expected access point or points operating on the selected channel for the channel scan. When the expected access point(s) are detected in the channel scan, the channel scan may be ended or abbreviated prior to the expiry of a default scan time for the channel scan.

The channel scan abbreviation may be used for various types of scans, but may be particularly advantageous for dynamic frequency selection (DFS) scans. In particular, wireless communications operating standards, such as the 802.11 standard, may identify certain frequencies of channels which the access points 124 typically operate on. However, non-DFS channels designated by the 802.11 standard may often be crowded, and hence to reduce congestion, the access points 124 may also operate on the DFS channels. Accordingly, channel scans may include both DFS and non-DFS channels. For DFS scans in particular, WiFi standards require passive scans until activity is detected on a DFS channel prior to switching to an active scan. Accordingly, DFS scans may take over 100 ms (or some other predetermined default scan time) to complete, which may increase the chances of dropping packets while the device 104 is away from the home access point channel during each individual channel scan. Once activity is detected, the passive scan may be ended entirely (e.g., if the detected access point is the sole expected access point as determined based on the neighbor list), or the passive scan may be converted to an active scan, which is typically faster than the passive scan.

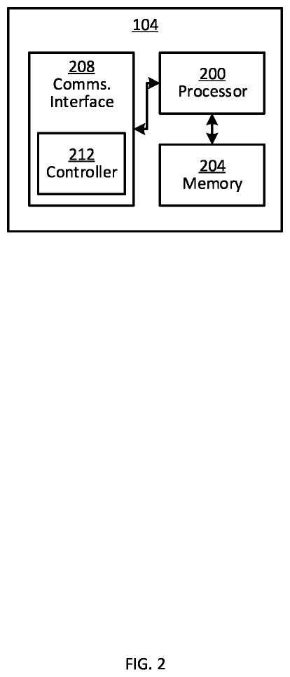

Turning now to FIG. 2, certain internal components of the computing devices 104 and 112 are illustrated. The device 104 includes a processor 200 interconnected with a non-transitory computer-readable storage medium, such as a memory 204. The memory 204 includes a combination of volatile memory (e.g., Random Access Memory or RAM) and non-volatile memory (e.g., read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the device 112. The communications interface 208 is interconnected with the processor 200. The communications interface 208 includes a controller 212, and one or more antennas, transmitters, receivers, or the like (not shown), to allow the device 104 to communicate with other computing devices such as the device 112 via the link 116.

The controller 212 may be a micro-controller, a micro-processor, or other suitable device capable of executing computer-readable instructions to control the components, such as the antennae, transmitters, receivers, and the like, of the communications interface 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein. In particular, the controller 212 may control an access point scan with a reduced scan time.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

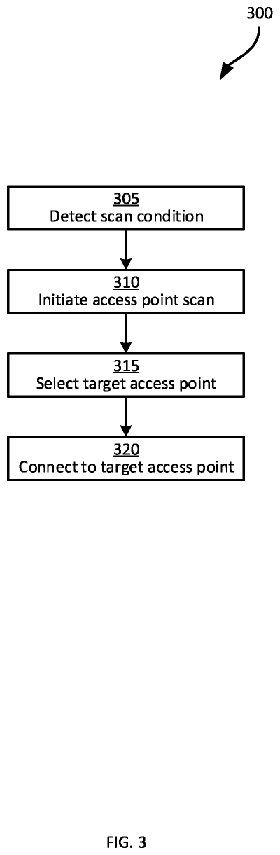

FIG. 3 illustrates a method 300 of connecting to a target access point. The method 300 will be discussed in conjunction with its performance in the system 100, and particularly by the device 104, with reference to the components of FIGS. 1 and 2. In other examples, the method 300 may be performed by other suitable devices and/or in other suitable systems.

The method 300 is initiated at block 305, where the device 104 may detect a scanning condition to initiate an access point scan. For example, if the device 104 is connected to the network 108 via the home access point 120, the scanning condition may be a detecting that a signal strength to the home access point 120 is below a threshold strength, that a quality of service (e.g., as determined based on jitter, latency, etc.) is below a predetermined threshold, or other similar conditions. That is, the scanning condition may be a roaming condition—a determination that the device 104 should roam to a different access point 124.

In other examples, the scanning condition may be initiated when the device 104 is not connected to the network 108. In such examples, the scanning condition may be the passage of a predetermined amount of time (e.g., if the device 104 performs a scan and predetermined intervals of time), initiation of the wireless communications interface 208, or other similar conditions.

At block 310, in response to detecting the scanning condition, the device 104 initiates an access point scan. As a result of the access point scan, the device 104 may identify nearby access points as well as operating channels for each access point. The device 104 may further identify a signal strength and/or quality of service indicator for each access point to allow the device 104 to select a target access point having a highest quality of service, signal strength, or other factor amongst the nearby access points.

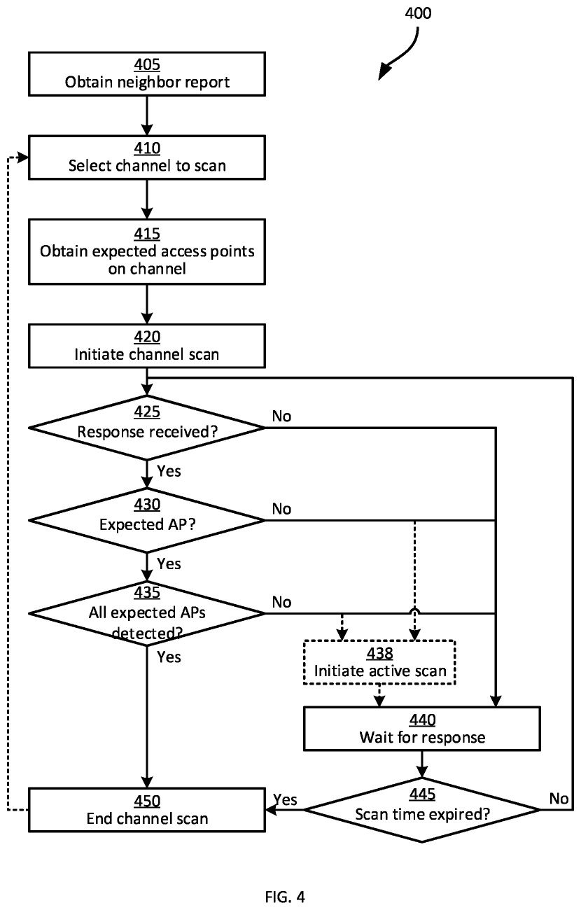

FIG. 4 depicts a flowchart of an example method 400 of performing an access point scan. The method 400 is initiated at block 405, where the device 104 obtains a neighbor report. In particular, the neighbor report may include a list of access points of the network 108 as well as the operating channels of those access points.

In some examples, the device 104 may obtain the neighbor report from the home access point 120 to which the device 104 is currently connected. In other examples, the device 104 may obtain the neighbor report from nearby computing devices 128 over a communication protocol independent of the network 108. For example, the device 104 may broadcast a neighbor report request via a short-range communications protocol, such as Bluetooth or similar. For example, in the example illustrated in FIG. 1, the neighbor report may identify the access point 124-1 and its operating channel as well as the access point 124-2 and its operating channel.

After obtaining the neighbor report at block 405, the device 104 may additionally determine a channel list of channels to scan. In particular, the channel list may be filtered from the channels available to the device 104 based on the neighbor report. That is, the channel list may be composed of channels which appear on the neighbor report. The channel list therefore includes channels on which an access point is expected to be operating. More particularly, the device 104 may expect that access points appearing in the neighbor report (and therefore operating on a channel in the channel list) may be favorable. Accordingly, the channel list may provide a reduced list of channels to scan and the resulting access points detected on those channels may be more likely to have favorable connection parameters (e.g., strong signal strength, high quality of service, etc.) for the device 104.

At block 410, the device 104 selects a channel to scan. The device 104 may select a channel from the channel list determined based on the neighbor report, or the device 104 may select another available channel as appropriate.

At block 415, the device 104 obtains the expected access points for the channel selected at block 410 based on the neighbor report. That is, the expected access points are the access points identified on the neighbor report as operating on the selected channel. When the channel is selected at block 410 from the channel list, the device 104 may identify at least one expected access point and may identify more than one expected access point. In some examples when the channel is not selected from the channel list, there may be no expected access points on the channel.

The expected access points, having been identified by the neighbor report, may represent access points which the device 104 is expecting favorable connection parameters, such as high signal strength, high quality of service parameters (e.g., low jitter and/or low latency), or the like. Accordingly, the expected access points may represented the access points which present the highest likelihood of being selected as a result of the access point scan as a target access point for roaming or for connecting to the network 108.

At block 420, the device 104 initiates a channel scan on the channel selected at block 410. That is, the device 104 may switch to the selected channel and wait to detect a beacon or response from any access points operating on the selected channel. When permitted by the wireless protocol operating standards, the device 104 may perform an active channel scan and send a probe to request responses from access points operating on the channel. When restricted by the wireless protocol operating standards (such as in the case of a DFS channel scan), the device 104 may perform a passive channel scan and simply wait passively to receive a beacon which is broadcast periodically by access points operating on the channel. At block 420, the device 104 may additionally initiate a scan timer having a predefined default scan time. The predefined default scan time may be, for example, 100 ms, or another appropriate duration.

At block 425, the device 104 determines if a response or beacon is received. If no responses or beacons have been received on the channel from any access points, then the device 104 proceeds to block 440 to continue to wait for a response.

If, at block 425, the device 104 receives a response or a beacon from an access point, then the device 104 proceeds to block 430 to process the response. At block 430, the device 104 determines whether the access point from which the device 104 received the response is one of the expected access points obtained at block 415. That is, the device 104 determines whether the access point was identified on the neighbor report.

If the determination at block 430 is negative, that is, the access point from which the response was received is not an expected access point, then the device 104 proceeds to block 440 to continue waiting for additional responses from other access points operating on the channel.

If the determination at block 430 is affirmative, that is, the access point from which the response was received is one of the expected access points, then the device 104 proceeds to block 435. At block 435, the device 104 determines whether all the expected access points identified at block 415 have been detected. That is, the device 104 determines whether responses have been received from each of the expected access points identified at block 415.

If the determination at block 435 is negative, that is, there are still expected access points from which a response has not been received, then the device 104 proceeds to block 440 to continue to wait for additional responses from other access points operating on the channel.

In some examples, after receiving a first beacon from an access point operating on the selected channel, the device 104 may convert a passive scan to an active scan. In particular, active scans may generally be quicker than passive scans, since the device 104 actively sends a probe requesting a response from the access points operating on the selected channel. Accordingly, particularly for DFS scans in which active scans are prohibited until a beacon is detected during a passive scan, the device 104 may proceed to block 438 after a negative determination at block 430 or 435. At block 438, the device 104 initiates an active scan, for example by sending a probe or request for responses on the selected channel. After converting the passive scan to an active scan, the device 104 may proceed to block 440 to continue waiting for responses.

If the determination at block 435 is affirmative, that is, there all the expected access points operating on the selected channel have been detected (i.e., by receiving a response and/or beacon from the expected access point), then the device 104 proceeds to block 450. At block 450, the device 104 ends the channel scan. In particular, performance of block 450 to end the channel scan after an affirmative determination at block 435 may cause the channel scan to be ended prior to the expiry of the default scan time. That is, the channel scan may be abbreviated to reduce the scan time for the channel scan. Since the expected access points are expected to be access points having favorable connection parameters, it may be assumed that other access points operating on the channel from which responses were not received during the abbreviated scan time are unlikely to have been selected as a target access point, and hence their omission from the access points detected during the access point scan is unlikely to affect the selection of the target access point.

After waiting for a response at block 440, the device 104 proceeds to block 445. At block 445, the device 104 determines whether a predetermined default scan time has expired. If the determination at block 445 is negative, that is, the default scan time has not yet expired, the device 104 returns to block 425 to determine whether any additional responses have been received.

If the determination at block 445 is affirmative, that is, the default scan time has expired, then the device 104 proceeds to block 450 to end the channel scan. In this case, the channel scan is not abbreviated from the regular default scan time.

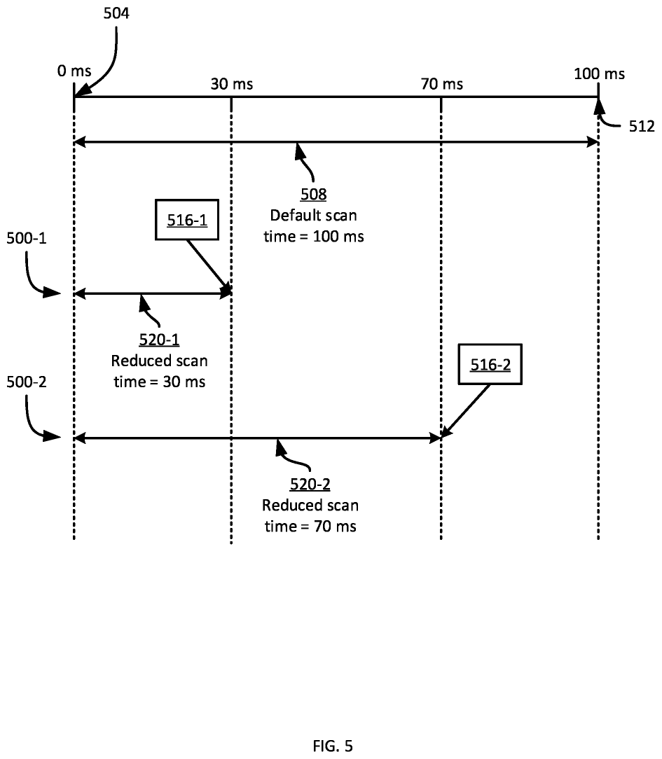

Turning to FIG. 5, a schematic diagram of the timeline of example channel scans 500-1 and 500-2 are depicted. Each channel scan 500 may be initiated at 504, at a time of 0 ms, have a default scan time 508 of 100 ms, and a hence may end at 512, at 100 ms. Over the duration of the channel scans 500, the access points 124-1 and 124-2 may be configured to send beacons 516-1 and 516-2, respectively, coinciding with 30 ms and 70 ms after the start 504 of the channel scans 500.

Thus, if the access points 124-1 and 124-2 are operating on different channels, then, during the first channel scan 500-1, the access point 124-1 may be the sole expected access point operating on the channel and identified at block 415 based on the neighbor report. The device 104 may detect the beacon 516-1 when it is transmitted at 30 ms. Since the access point 124-1 is the sole expected access point, the device 104 determines at block 435 that all expected access points have been detected after detecting the beacon 516-1, and hence the first channel scan 500-1 may have a reduced scan time 520-1 of 30 ms (i.e., coinciding with the time of receipt of the beacon 516-1).

Similarly, during the second channel scan 500-2, the access point 124-2 may be the sole expected access point operating on the second channel and identified at block 415 based on the neighbor report. The second channel scan 500-2 may therefore be abbreviated after detecting the beacon 516-1, resulting in a reduced scan time 520-2 of 70 ms.

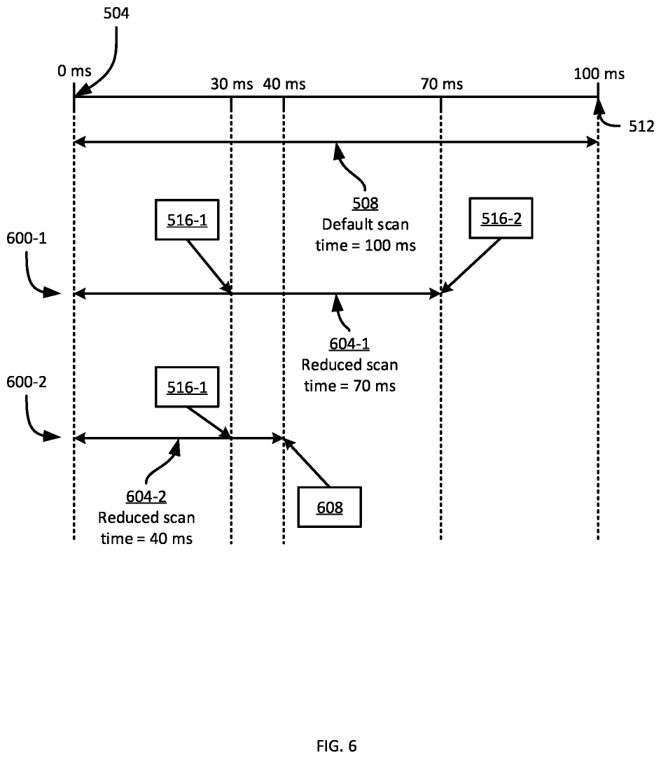

Turning now to FIG. 6, a schematic diagram of a timeline is depicted when the access points 124-1 and 124-2 are operating on the same channel. In such examples, both access points 124-1 and 124-2 may be identified at block 415 as being expected access points based on the neighbor report.

According to a first example, the device 104 may initiate and maintain a passive channel scan 600-1. Accordingly, the device 104 may receive the beacon 516-1 from the access point 124-1 at 30 ms and determine at block 435 that not all expected access points have been detected, and hence may continue to wait for a response at block 440. Subsequently, upon detecting the beacon 516-2 from the access point 124-2 at 70 ms, the device 104 may determine at block 435 that all expected access points have now been detected and that the channel scan 600-1 may be abbreviated with a reduced scan time 604-1 of 70 ms, when the last of the expected access points is detected.

According to a second example, the device 104 may perform a passive-to-active scan conversion during the channel scan 600-2. This may particularly be applicable when the channel scan 600-2 is a DFS channel scan. That is, the device 104 may receive the beacon 516-1 from the access point 124-1 at 30 s and may determine at block 435 that not all expected access points have been detected. The device 104 may then proceed to block 438 to initiate an active scan. In particular, the device 104 may send out a probe on the channel requesting a response from access points operating on the channel. In particular, the device 104 may send the probe within 5 ms, and may receive responses to the probe within an additional 5 ms. Accordingly, the device 104 may receive a response 608 from the access point 124-2 by 40 ms after the start 504. After receiving the response 608 from the access point 124-2, the device 104 may determine at block 35 that all expected access points have now been detected and that the channel scan 600-2 may be abbreviated with a reduced scan time 604-2 of 40 ms.

Returning to FIG. 4, after ending the channel scan at block 450, the device 104 may then return to the operating channel of the home access point 120 (i.e., if the device 104 was connected to the network and moved away from the home access point 120 to perform the channel scan), and complete incoming and outgoing transmission operations which were buffered during the channel scan. When the channel scan is abbreviated, the duration of buffering time for the incoming and outgoing transmissions is also reduced, and hence there is a lower likelihood of packets being dropped.

After ending the channel scan, if there are additional channels to scan (e.g., from the channel list defined at block 405 from the neighbor report), then the device 104 may return to block 410 to select another channel to scan. The device 104 similarly applies the expected access points to reduce the duration of each channel scan and may return to the home access point 120 between each channel scan to complete ingoing and outgoing transmission operations to maintain communications between the device 104 and other computing devices, such as the device 112 over the duration of the access point scan.

Returning to FIG. 3, after completing the access point scan, at block 315, the device 104 selects a target access point based on the access point scan. The device 104 may select the target access point based on the relative signal strengths to the detected access points, the quality of service of the detected access points, combinations of the above, and other connection parameters. Since channel scans are restricted based on the neighbor report, access points with relatively high signal strengths and/or quality of service may be expected to be detected by the access point scan. The detected access points resulting from the access point scan may therefore provide a shortlist of good quality access points for selecting a target access point.

At block 320, the device 104 connects to the selected target access point. The connection may be a roam from the home access point 120 to the selected target access point, or the connection may be a new initial connection to connect to the network 108.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising:
a wireless communications interface configured to connect to a network deployed by a plurality of access points;
a controller for the wireless communications interface, the controller configured to:
initiate an access point scan to identify nearby access points of the plurality of access points;
during the access point scan:
obtain a neighbor report, the neighbor report defining a subset of the plurality of access points and an operating channel for each access point in the subset;
select a channel to scan and identify an expected access point operating on the selected channel based on the neighbor report;
initiate a channel scan to detect the expected access point on the selected channel; and
in response to detecting the expected access point, end the channel scan prior to expiry of a default scan time; and
connect to a target access point selected based on the access point scan.

2. The computing device of claim 1, wherein the controller is further configured to:
determine, based on the neighbor report, a channel list of the operating channels for the access points in the subset; and
select the channel to scan from the channel list.

3. The computing device of claim 2, wherein the controller is to initiate the channel scan for each operating channel in the channel list.

4. The computing device of claim 1, wherein the controller is configured to:
identify a plurality of expected access points operating on the channel based on the neighbor report; and
end the channel scan prior to expiry of the default scan time in response to detecting each of the plurality of expected access points.

5. The computing device of claim 4, wherein the controller is configured to in response to receiving a first response from a first expected access point of the plurality of expected access points, initiate an active channel scan for a remainder of the plurality of expected access points.

6. The computing device of claim 1, wherein the channel scan comprises a dynamic frequency selection scan.

7. The computing device of claim 1, wherein, after ending the channel scan, the controller is configured to return to a home access point to complete buffered incoming and outgoing transmissions.

8. The computing device of claim 1, wherein the controller is configured to obtain the neighbor report from a home access point to which the computing device is connected.

9. A method comprising:
initiating an access point scan to identify nearby access points of a plurality of access points;
during the access point scan:
obtaining a neighbor report from nearby computing devices, the neighbor report defining a subset of the plurality of access points and an operating channel for each access point in the subset;
selecting a channel to scan and identify an expected access point operating on the selected channel based on the neighbor report;
initiating a channel scan to detect the expected access point on the selected channel; and
in response to detecting the expected access point, ending the channel scan prior to expiry of a default scan time; and
connecting to a target access point selected based on the access point scan.

10. The method of claim 9, further comprising:
determining, based on the neighbor report, a channel list of the operating channels for the access points in the subset; and
selecting the channel to scan from the channel list.

11. The method of claim 10, further comprising initiating the channel scan for each operating channel in the channel list.

12. The method of claim 9, further comprising:
identifying a plurality of expected access points operating on the channel based on the neighbor report; and
ending the channel scan prior to expiry of the default scan time in response to detecting each of the plurality of expected access points.

13. The method of claim 12, further comprising: in response to receiving a first response from a first expected access point of the plurality of expected access points, initiating an active channel scan for a remainder of the plurality of expected access points.

14. The method of claim 9, wherein the channel scan comprises a dynamic frequency selection scan.

15. The method of claim 9, further comprising, after ending the channel scan, returning to a home access point to complete buffered incoming and outgoing transmissions.

16. The method of claim 9, further comprising obtaining the neighbor report from a home access point to which the computing device is connected.
